(19) United States
(12) Patent Application Publication
(10) Pub. No.: US 2022/0318706 A1
(43) Pub. Date: Oct. 6, 2022

(54) INCENTIVE-BASED DATA EXCHANGE

(71) Applicant: AT&T Intellectual Property I, L.P., Atlanta, GA (US)

(72) Inventors: James Fan, San Ramon, CA (US); Steven Polston, Flemington, NJ (US); Sanjay Agraharam, Marlboro, NJ (US); Michelle Martens, Freehold, NJ (US); Arun Gupta, Manalapan, NJ (US)

(21) Appl. No.: 17/219,852

(22) Filed: Mar. 31, 2021

(51) Int. Cl. G06Q 10/06; G06F 16/2455; G06F 16/23

(52) U.S. Cl. CPC G06Q 10/06311; G06F 16/24558; G06F 16/2379

(57) ABSTRACT

A method includes receiving a first request from a first user endpoint device of a first user, wherein the first request specifies a data need of the first user, identifying a first dataset from among a plurality of datasets, wherein the first dataset is determined to match the data need, determining a resource need of a second user who controls the first dataset, wherein the resource need is specified in a second request from a second user endpoint device of the second user, determining that the first user can provide a first resource that satisfies the resource need, wherein the first resource is offered by the first user, establishing an agreement upon approval from the first user and from a second user to orchestrate an exchange of the first dataset for the first resource, and delivering the first dataset to the first user endpoint device via a data pipeline.

The present disclosure relates generally to data management, and relates more particularly to devices, non-transitory computer-readable media, and methods for using incentives to encourage the sharing of datasets.

### BACKGROUND

Access to data can be critical for an enterprise. For instance, different projects within an enterprise may require access to different types of data for testing, model building, and other phases of project development. For these reasons, data can be incredibly valuable.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for using incentives to encourage the sharing of datasets may operate;

FIG. 2 illustrates one example of the exchange manager of FIG. 1 in greater detail;

FIG. 3 illustrates a flowchart of an example method for delivering access to datasets using an incentive-based exchange, in accordance with the present disclosure; and

FIG. 4 depicts a high-level block diagram of a computing device or processing system specifically programmed to perform the functions described herein.

To facilitate understanding, similar reference numerals have been used, where possible, to designate elements that are common to the figures.

### DETAILED DESCRIPTION

The present disclosure broadly discloses methods, computer-readable media, and systems for delivering access to datasets using an incentive-based exchange. In one example, a method performed by a processing system includes receiving a first request from a first user endpoint device of a first user of a data exchange, wherein the first request specifies a data need of the first user, identifying a first dataset from among a plurality of datasets that is accessible via the data exchange, wherein the first dataset is determined to match the data need of the first user, determining a resource need of a second user who controls access to the first dataset, wherein the resource need is specified in a second request from a second user endpoint device of the second user, determining that the first user can provide a first resource that satisfies the resource need, wherein the first resource is offered by the first user via the data exchange, establishing an agreement upon approval from the first user and from the second user to orchestrate an exchange of the first dataset for the first resource, and delivering, pursuant to the agreement, the first dataset to the first user endpoint device via a data pipeline.

In another example, a non-transitory computer-readable medium may store instructions which, when executed by a processing system in a communications network, cause the processing system to perform operations. The operations may include receiving a first request from a first user endpoint device of a first user of a data exchange, wherein the first request specifies a data need of the first user, identifying a first dataset from among a plurality of datasets that is accessible via the data exchange, wherein the first dataset is determined to match the data need of the first user, determining a resource need of a second user who controls access to the first dataset, wherein the resource need is specified in a second request from a second user endpoint device of the second user, determining that the first user can provide a first resource that satisfies the resource need, wherein the first resource is offered by the first user via the data exchange, establishing an agreement upon approval from the first user and from the second user to orchestrate an exchange of the first dataset for the first resource, and delivering, pursuant to the agreement, the first dataset to the first user endpoint device via a data pipeline.

In another example, a device may include a processing system including at least one processor and non-transitory computer-readable medium storing instructions which, when executed by the processing system when deployed in a communications network, cause the processing system to perform operations. The operations may include receiving a first request from a first user endpoint device of a first user of a data exchange, wherein the first request specifies a data need of the first user, identifying a first dataset from among a plurality of datasets that is accessible via the data exchange, wherein the first dataset is determined to match the data need of the first user, determining a resource need of a second user who controls access to the first dataset, wherein the resource need is specified in a second request from a second user endpoint device of the second user, determining that the first user can provide a first resource that satisfies the resource need, wherein the first resource is offered by the first user via the data exchange, establishing an agreement upon approval from the first user and from the second user to orchestrate an exchange of the first dataset for the first resource, and delivering, pursuant to the agreement, the first dataset to the first user endpoint device via a data pipeline.

Recognizing a match between dataset requirements among multiple data requests may suggest the use of a common data model or lexicon parser as a basis for data typing and consistency of value ranges. In an example using artificial intelligence (AI) and/or machine learning (ML), a predefined and generalized AI/ML algorithm model may be used to infer the generalized data pipeline requirements and to enable the mapping and comparison of models and attributes.

As discussed above, access to data can be critical for an enterprise. For instance, different projects within an enterprise may require access to different types of data for testing, model building, and other phases of project development. For these reasons, data can be incredibly valuable. However, data is not always readily available when needed, and in most cases there is no mechanism that enables the value of the data to be realized or exchanged for resources of equal value. For instance, even though an enterprise may specify data sharing policies among work groups, different project priorities may still make it difficult for data users to gain access to valuable datasets in a timely manner. In some cases, data users may not even be aware of the existence of newly created datasets for months. Even where a data user is aware of a well-known dataset and has requested access to the well-known dataset, the request can be delayed due to the time involved in gaining approval and/or to being placed in a queue for data access due to limited resources in the data owner side.

Moreover, although matching requests for data to well-known datasets is generally straightforward, there is a need, for undocumented datasets, for some way to either contribute artifacts or dynamically generate artifacts through observation of the data stream. For instance, if different projects each contribute their data pipeline requirements and model definition/abstraction artifacts into the solution, then the approach described above may work well. In other examples, generic anomaly detectors and other tooling than can infer data and relationships from processing data streams and recognizing or estimating matches (with some confidence) may work. Some of the most practical beneficiaries of the present disclosure, however, may include internal projects, open source communities sharing models, and communities of interest sharing standards (e.g., such as The Business Process Framework (eTOM) or the TNForum global industry association).

Examples of the present disclosure provide an exchange via which incentives may be provided for data owners who are willing to provide others with access to their datasets. In one example, the incentives may take the form of access to other types of resources which may provide value to the data owners. Thus, the data owners may receive fair value for their datasets in a manner that benefits all parties and increases overall enterprise productivity. The exchange may also allow users to more easily determine the types of data that are available and the types of data that are needed by others, which also increases productivity.

For instance, suppose a data user within an enterprise comprises a group including three developers, two testers, and two modelers to support two different in-house projects. The first project may be in the middle of the finalization stage, while the second project may be in the requirement and data specification stage. Thus, one modeler, or fifty percent of the data user's modeling resources, may be idle. Typically, the idle modeler might be encouraged to seek out further training in order to ensure that time may be properly charged to the projects without unnecessarily consuming project funding; however, this does nothing to help expedite the second project. On the other hand, by using the exchange disclosed herein, the data user may offer the services of the idle modeler (e.g., fifty percent of the data user's modeling resources) to help another data user (e.g., enterprise group) perform new model building and, in return, gain access to data needed to complete the requirement and data specification stage of the second project more quickly.

Examples of the present disclosure offer an enabling framework which allows data owners and data users to trade needed data for useful resources. This incentive-based approach support dual business goals by: (1) providing a framework for data users to trade their available resources (which may be provided for a defined period of time) such as expertise, personnel, computing resources, and the like for valuable data offered by potential data owners (thereby encouraging data owners to share their valuable datasets; and (2) allowing data owners who need resources to complete their projects, models, jobs, and the like to post their available datasets to proactively recruit data users (and obtain the needed resources in return to save project cost and improve time to market factor).

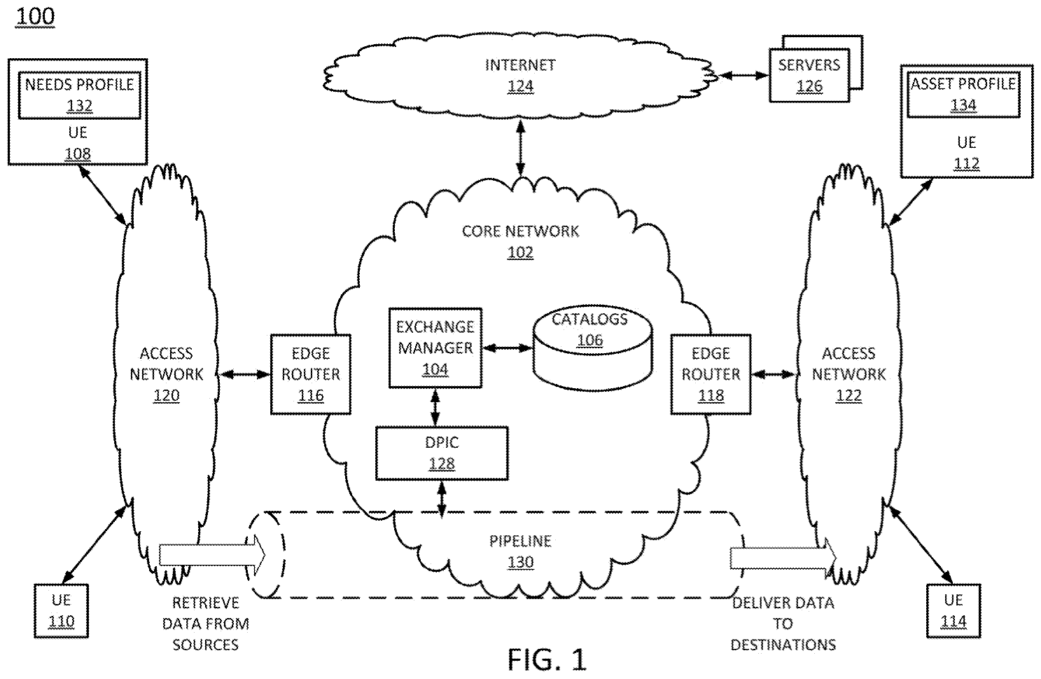

Thus, examples of the present disclosure facilitate the sharing of data in a manner that is fair, efficient, and useful, where such sharing would otherwise be difficult or impossible due to different ownership and/or enterprise policies. As an additional benefit, examples of the present disclosure may make data sharing fun by turning passive compliance culture into a proactive trading paradigm, which encourages an even greater degree of sharing. Over time, an enterprise architect may be able to achieve platform-based solutions sooner, because most reliable data owners' datasets will gain the status quo as the standard. Duplicate datasets may gradually disappear, which is beneficial to the enterprise since the cost of maintaining duplicated datasets is relatively high. These and other aspects of the present disclosure are discussed in greater detail below in connection with the examples of FIGS. 1-4.

To further aid in understanding the present disclosure, FIG. 1 illustrates an example system 100 in which examples of the present disclosure for using incentives to encourage the sharing of datasets may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least an incentive-based data exchange manager (“exchange manager”) 104, at least one set of exchange catalogs 106, a data pipeline intelligent controller (DPIC) 128, and a plurality of edge routers 116-118. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider. The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

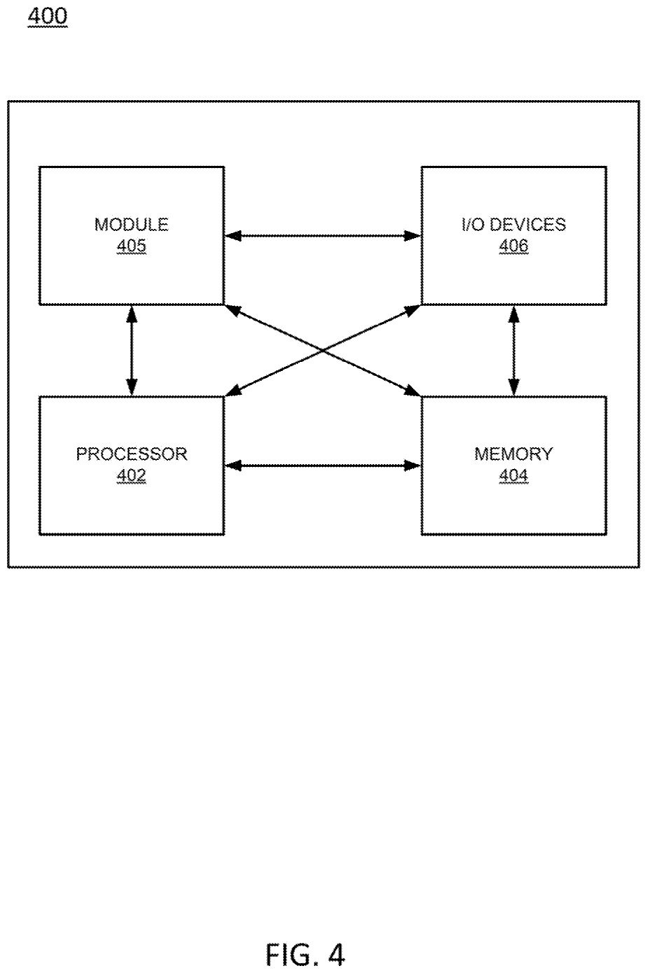

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the exchange manager 104, other components of the core network 102, devices reachable via the Internet in general, and so forth. In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, an Internet of Things (IoT) device, a wearable smart device (e.g., a smart watch, a fitness tracker, a head mounted display, or Internet-connected glasses), an application server, a bank or cluster of such devices, and the like. To this end, the user endpoint devices 108, 110, 112, and 114 may comprise one or more physical devices, e.g., one or more computing systems or servers, such as computing system 400 depicted in FIG. 4, and may be configured as described below.

In one example, at least one of the user endpoint devices 108, 110, 112, and 114 is operated by a data owner. User endpoint device 112, for instance, may represent an example user endpoint device that is operated by a data owner. The data owner may be an individual who creates, owns, or otherwise has control over a dataset that is made available for sharing through the system 100. In one example, a user endpoint device 108, 110, 112, or 114 that is operated by a data owner may include a data owner asset profile repository 134 to store profiles of datasets that are made available for sharing by the data owner. The data owner asset profile 134 may include at least a type of the data in the available dataset (e.g., text, audio, video, images, sensor readings, charts, etc. as well as the subject matter to which the data pertains) and the conditions under which the available dataset can be shared (e.g., needs or goals to be met in order for a data user to gain access, such as type and amount of resources to be provided by the data user in exchange for the access).

In another example, at least one of the user endpoint devices 108, 110, 112, and 114 is operated by a data user. User endpoint device 108, for instance, may represent an example user endpoint device that is operated by a data user. The data user may be an individual who requires access to a dataset that is made available for sharing through the system 100. In one example, a user endpoint device 108, 110, 112, or 114 that is operated by a data user may include a data user needs profile repository 132 to store profiles of datasets that are needed or requested by the data user. The data user needs profile 132 may include at least a type of the data in the needed dataset (e.g., text, audio, video, images, sensor readings, charts, etc. as well as the subject matter to which the data pertains) and a description of the resources (e.g., type and amount) that the data user is willing to provide in exchange for the needed dataset.

In one example, one or more servers 126 may be accessible to user endpoint devices 108, 110, 112, and 114 via the Internet 124 in general. The server(s) 126 may operate in a manner similar to the exchange manager 104, which is described in further detail below.

In accordance with the present disclosure, the exchange manager 104 and exchange catalogs 106 may be configured to provide one or more operations or functions in connection with examples of the present disclosure for using incentives to encourage the sharing of datasets, as described herein. For instance, the exchange manager 104 may be configured to operate as a Web portal or interface via which a user may search for or post information relating to datasets and/or resources that are available for sharing. A user endpoint device, such as any of the UEs 108, 110, 112, and/or 114 (e.g., wireless devices), may access a service on the exchange manager 104 that enables the exchange of datasets and resources.

To this end, the exchange manager 104 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

For instance, in one example, the exchange manager 104 (e.g., a remote device or server) may obtain, from one of the user endpoint devices 108, 110, 112, or 114, a profile indicating the needs and/or available resources of a user of the user endpoint device. For instance, as discussed above, where the user is a data owner, the profile may be stored in the data owner asset profile repository 134 and describe a dataset that the data owner is willing to make available to data users, as well as any resources that the data owner is seeking in exchange for access to the dataset. Where the user is a data user, the profile be stored in the data user needs profile repository 132 and may describe a dataset that the data user is seeking access to, as well as any resources that the data user is willing to make available in exchange for access to the needed dataset.

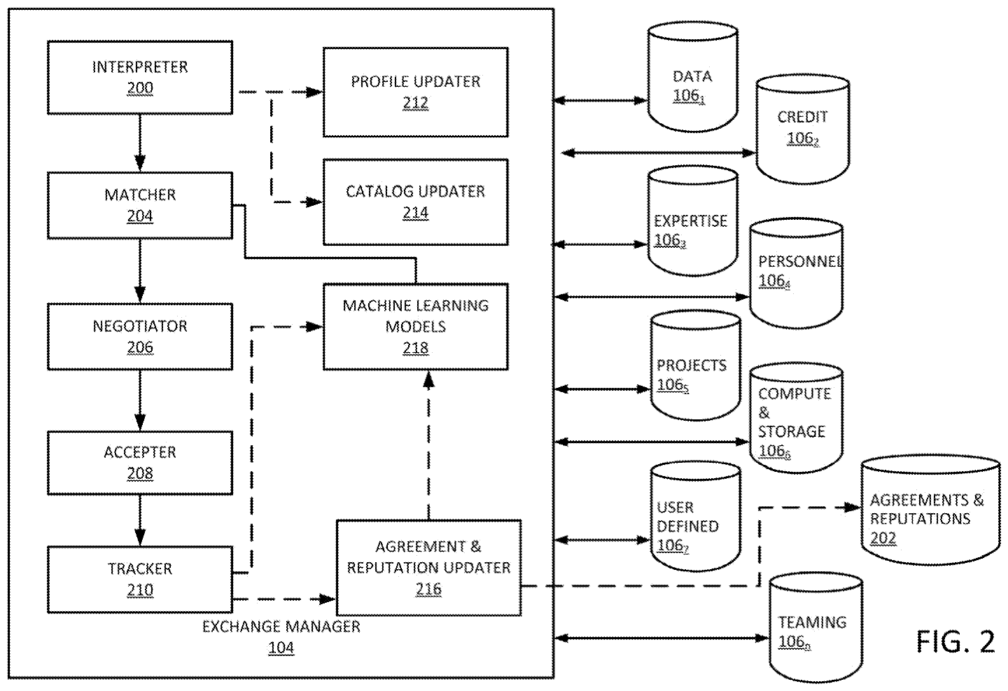

FIG. 2 illustrates one example of the exchange manager 104 of FIG. 1 in greater detail. As illustrated, the exchange manager 104 may include the following processing systems, each of which is described in greater detail below: profile & request catalog interpreter (“interpreter”) 200, a needs and assets analyzer & matcher (“matcher”) 204, a data trading negotiator (“negotiator”) 206, a data sharing agreement accepter (“accepter”) 208, a data settlement executor & update tracker (“tracker”) 210, a profile updater 212, a catalog updater 214, an agreement and reputation updater 216, and machine learning models 218.

As illustrated in FIG. 1, the exchange manager 104 may have access to at least one set of exchange catalogs 106, where the exchange catalogs 106 may store information related to datasets and/or resources that users of the system 100 are willing to offer for sharing and exchange. In one example, illustrated in FIG. 2, a plurality of individual catalogs 106₁-106ₙ (hereinafter individually referred to as a “catalog 106” or collectively referred to as “catalogs 106”) may be accessible to the exchange manager 104, where each of the catalogs 106 may store a different type of data. For instance, the catalogs 106 may include the following catalogs, each of which is described in greater detail below: a data catalog 106₁, a credit catalog 106₂, an expertise catalog 106₃, a personnel capabilities catalog 106₄, a projects catalog 106₅, a compute & storage catalog 106₆, a user defined catalogs 106₇, and a teaming catalog 106ₙ. In one example, the plurality of catalogs 106 may comprise views of catalog infrastructure or instances of the catalog infrastructure for the communities that define and consume the views. In further examples, any of the catalogs 106 may be omitted, or additional catalogs 106 may be included. Furthermore, any one or more of the catalogs 106 may be combined into a single database.

In one example, the data catalog 106₁ may operate as a trading catalog that stores datasets to which data owners may offer access in exchange for needed resources (where the needed resources may comprise computing resources, personnel resources, financial resources, other datasets, and other types of resources). In one example, the data catalog 106₁ may include a basic description of an available dataset, such that data users may be able to determine what type of data is available without being able to view the actual data. For instance, it may be inferred that generalized data definition artifacts are used to view the data required for a pipeline without exposing actual data and values to the users who may not (at least not yet) have the authorization to view the data.

In one example, the credit catalog 106₂ may operate as a trading catalog that stores information about various means or currencies by which data users may access datasets stored in the data catalog 106₁. In other words, the credit catalog 106₂ may store credit mechanisms (e.g., computing resources, personnel resources, financial resources, other datasets, and other types of resources) which may be redeemed by data owners who have granted data users access to their datasets. In one example, credits stored in the credit catalog 106₂ can be traded, transferred, or even given as gifts.

In one example, the expertise catalog 106₃ may operate as a trading catalog that stores information about areas of expertise of data users. For instance, data users may specify skills or subject areas in which the data users have expertise (e.g. writing code in particular programming languages, creating presentation slides, performing data modeling, consultation, etc.), where the expertise may be offered by the data user in exchange for access to a data owner's dataset.

In one example, the personnel capabilities catalog 106₄ may operate as a trading catalog that stores information about groups of personnel capabilities that data users are willing to offer for a negotiated period of time in order to gain access to datasets. For example, a data owner can offer one project manager fifty percent of scheduled work hours and/or three testers forty percent time to help data owner for two weeks.

In one example, the projects capabilities catalog 106₅ may operate as a trading catalog that stores information about projects that are seeking resources. For instance, from a data owner's prospective, the projects capabilities catalog 106₅ may list projects for which the data owner needs resources in order to complete the projects more quickly. From a data user's prospective, the projects capabilities catalog 106₅ may define the data support that the data user needs for each of their projects. In one example, users do not transfer software licenses, but may instead offer the opportunity to obtain authorization as a privileged user for a defined period of time to explore sample data sets that have been cleansed for exploratory use. This may help the temporarily authorized users to make an informed determination as to whether a formal request for access to the data is worthwhile.

In one example, the compute & storage catalog 106₆ may operate as a trading catalog that stores information about computing and/or storage resources offered by data users in exchange for access to needed datasets.

In one example, the user defined catalog 106₇ may operate as a trading catalog that enables data users to exchange resources, subject to a set of policies, for dataset access. Such resources may not be explicitly described in any of the other catalogs. For instance, a data user may transfer some of its software licenses to a data owner for a period of time in exchange for access to a dataset of the data owner. Information about exchanges brokered using the user defined catalog 106₇ may also be stored in the user defined catalog 106₇ for later reuse.

In one example, the teaming catalog 106ₙ may operate as a trading catalog that stores information about teams of data users with similar needs who may be able to pool resources together to access needed datasets. Allowing data users to form teams in this manner may allow the data users to better negotiate with data owners. The teaming catalog 106ₙ also stores information about teams of data owners who have or control similar datasets. Allowing data owners to team in this manner may allow the data owners to offer more powerful datasets for use by data users. In short, the teaming catalog 106ₙ may enable a wide range of collaboration among data users and/or data owners. The matcher 204, described in greater detail below, may perform cross association for group matching with no limits.

In one example, all of the catalogs 106 and/or the exchange manager 104 may belong to and may be accessible exclusively to a single enterprise. For instance, an enterprise may deploy the exchange manager 104 and catalogs 106 in order to facilitate the sharing of data and resources among the enterprise's employees, resulting in greater employee productivity and cooperation. In a further example, a data user who is seeking access to a dataset, but currently has nothing to offer in exchange for access to the dataset (e.g., no idle resources), may write a “raincheck” to any of the catalogs 106. The raincheck may function as a generic voucher that can be redeemed at a later time by a data owner, when the data user has resources to spare.

In one example, each of the catalogs 106 may comprise a physical storage device integrated with the exchange manager 104 (e.g., a database server or a file server), or attached or coupled to the exchange manager 104, in accordance with the present disclosure. In one example, the exchange manager 104 may load instructions into a memory, or one or more distributed memory units, and execute the instructions for using incentives to encourage the sharing of datasets, as described herein. Example methods for delivering access to datasets using an incentive-based exchange are described in greater detail below in connection with FIGS. 2-4.

Referring back to FIG. 2, in one example, the various components of the exchange manager 104 are configured to automatically facilitate the exchange of a data user's resources for access to a data owner's dataset(s). In one example, the profile & request catalog interpreter 200 may interpret requests from data owners and data users. For instance, a request from a data owner may be triggered when a data owner publishes (e.g., in an asset profile or in the data catalog 106₁ as described above) a willingness to share a dataset with others and/or a need for resources for which the data owner is willing to exchange access to the dataset. A request from a data user may be triggered when a data user publishes (e.g., in an asset profile or in a DB such as the expertise catalog 106₃, the personnel capabilities catalog 106₄, or the like, as described above) a need for access to a dataset and/or resources which the data user is willing to provide in exchange for access to the dataset. In one example, whenever a request (or an update to an existing request) is triggered, the profile & request catalog interpreter 200 may validate the request and provide information extracted from the validated request to the profile updater 212 and/or the catalog updater 214.

Based on the information provided by the profile & request catalog interpreter 200, the profile updater 212 may update the information related to an asset profile and/or a needs profile, as described above. Similarly, based on the information provided by the profile & request catalog interpreter 200, the catalog updater may update the information related to any entities (e.g., datasets available for sharing, resources offered in exchange for datasets, etc.) stored in any of the catalogs 106.

The profile & request catalog interpreter 200 may also forward the validated request to the needs and assets analyzer & matcher 204. The needs and assets analyzer & matcher 204 may analyze the request and search the catalogs 106 for any information that can satisfy the request. For instance, if the request describes a dataset that a data owner is willing to provide access to in exchange for specific resources, the needs and assets analyzer & matcher 204 may search the catalogs 106 for information about data users who need access to data of the type contained in the offered dataset and who have offered to provide resources of the type that the data owner requires. Having located one or more potential matches, the needs and assets analyzer & matcher 204 may attempt to negotiate an exchange between the data owner and the data user (starting with the closest match first and working down a ranked list of potential matches until an exchange is accepted). The needs and assets analyzer & matcher 204 may employ one or more machine learning models 218 in order to learn how to match data owners and data users to arrange mutually beneficial exchanges.

The data trading negotiator 206 may access appropriate catalogs 106 to assist the needs and assets analyzer & matcher 204 with the negotiation process. If a negotiation does not result in agreement between a data owner and a data user, then the data owner and/or data user may be presented with the option to create user defined entries in the user defined catalog 106₇ (e.g., as long as corporate business conduct code is followed).

The data sharing agreement accepter 208 may provide any protocols needed to carry out an agreement (once reached) to exchange a dataset for resources.

The data settlement executor & update tracker 210 may ensure the delivery of the dataset to the data user and may track whether the data user's pledge to provide resources in exchange for the dataset has been fulfilled. In one example, the data settlement executor & update tracker 210 may log agreement obligations and settlements in a chain structure, so that responsibilities can be tracked in perpetuity per agreement lifecycle.

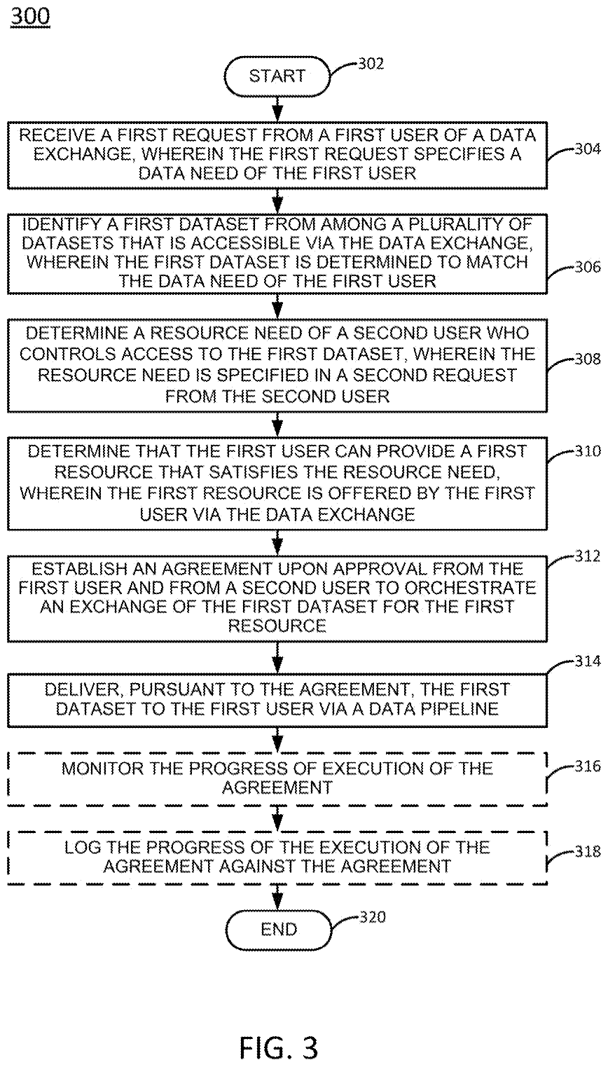

The data settlement executor & update tracker 210 may also forward a delivery request to the DPIC 128 to deliver the dataset to the data user, where the DPIC 128 may use a data pipeline 130 to retrieve and deliver the dataset. The DPIC 128 may control all the elements of the data pipeline 130 to enable the data pipeline 130 to create a suitable response to satisfy a user request. The functions, or modules, of the DPIC 128 may include, but are not limited to: schedulers, request interpreters, various artificial intelligence/machine learning modules, policy functions, security and privacy enforcement modules, assurance functions, negotiation functions, orchestrators, databases, an abstract symbol manipulator module, a model data schema generator/updater, and so forth. As described in further detail below in connection with steps 316-318 of FIG. 3, the progress of an exchange may be monitored and logged to ensure that all terms of the exchange are fulfilled. In one example, execution of the processing against a dataset may be captured in job-level metadata that can be collected and audited for reporting, compliance, use, performance, and settlements.

In one example, the DPIC 128 may create new schemas to handle new source data retrievals and/or to integrate new data pipeline component types, and may assemble and tear down data pipelines in real-time. In one example, the DPIC 128 is flexibly expandable via add-ons, plug-ins, helper applications, and the like. When a user, such as a data scientist, a network operator, or the like seeks to obtain specified datasets from multiple sources (e.g., to provide to one or more machine learning models as target(s)), the user may provide the request by specifying the desired dataset and the desired target(s), and the DPIC 128 may automatically generate an end-to-end plan to obtain and transmit the right dataset from the right source(s) (e.g., data owners(s)) to the right target(s) (e.g., data user(s)). Thus, the present disclosure provides for intelligent control of data pipelines (such as data pipeline 130) via the DPIC 128 which automatically integrates and directs data pipeline components at a higher level of abstraction. Data pipelines may be constructed dynamically by the DPIC 128, and on an as-needed basis such that even complex or demanding user requests may be fulfilled without (or with minimal) human interaction, and without component-specific human expertise regarding the various data pipeline components. The ability to create new schemas may imply version controls, in which case version semantics may be employed for types of backward and forward compatibility.

In many cases, a data pipeline or its associated support functions are in existence, but the data pipeline itself may be inactive. In other cases, a data pipeline may not be physically or virtually established, but all the support functions are available in the cloud. In response to a request for dataset transfer, examples of the present disclosure may activate an inactive data pipeline or may form a new data pipeline in real-time. Examples of the present disclosure may further include features for: security, access, authentication, and authorization (AAA), (for instance, a requesting data user may not have the right to access a dataset; the present disclosure may take the role to gain rights for protected dataset(s)), accounting services, proxy creation, protocol setting, payment settlement, and so on.

The agreement & reputation updater 216 may receive updates regarding the delivery of datasets to data users and/or the delivery of resources to data owners from data settlement executor & update tracker 210 and may, in response to the updates, update an agreements & reputations repository 202. The agreements & reputations repository 202 may contain historical data regarding agreements that have been arranged (e.g., the datasets and/or resources involved in the exchange, any evidence confirming that the exchange was carried out and that the data owner and data user fulfilled their obligations, etc.). The agreements & reputations repository 202 may also contain data regarding the reputations of data owners and data users, where the reputations may indicate the data owners' and data users' histories regarding fulfillment of agreements (e.g., whether and how long it took a data owner or data user to fulfill their obligations in the past).

Agreement execution results, reputations, and catalog effectiveness feedbacks may be provided to the machine learning models 218 as new training data to improve the predictions and recommendations made by the needs and assets analyzer matcher 204.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 3 illustrates a flowchart of an example method 300 for delivering access to datasets using an incentive-based exchange, in accordance with the present disclosure. For instance, steps, functions and/or operations of the method 300 may be performed by a device as illustrated in FIG. 1, e.g., exchange manager 104 or any one or more components thereof. In one example, the steps, functions, or operations of method 300 may be performed by a computing device or system 400, and/or a processing system 402 as described in connection with FIG. 4 below. For instance, the computing device 400 may represent at least a portion of the exchange manager 104 in accordance with the present disclosure. For illustrative purposes, the method 300 is described in greater detail below in connection with an example performed by a processing system, such as processing system 402.

The method 300 begins in step 302 and proceeds to step 304. In step 304, the processing system may receive a first request from a first user of a data exchange, where the first request specifies a data need of the first user. In one example, the first user may be a data user, e.g., an employee or member of an enterprise who requires a particular type of data (e.g., text, audio, video, images, sensor readings, charts, or the like) for testing, model building, or another phase of project development. The first request may be received by the processing system via a web portal that allows the first user to build and publish a profile that is stored as part of the data exchange, where the profile describes the data need.

In step 306, the processing system may identify a first dataset from among a plurality of datasets that is accessible via the data exchange, where the first dataset is determined to match the data need of the first user. In one example, each dataset of the plurality of datasets may belong to a data owner, where each data owner may be an employee or member of the same enterprise as the data user. Each dataset may be provided by its respective data owner for possible usage by data users of the enterprise. For instance, a data owner may build and publish a profile (e.g., using a web portal) that describes the dataset. Information describing the dataset may also be stored in a database or catalog that serves as a repository for all datasets that are available for sharing via the data exchange. In one example, the first dataset (or an entry in the database for the first dataset) may be determined to match the data need of the first user when metadata associated with the first dataset matches a keyword in the first request. In one example, the match between the metadata and the keyword need not be an exact match; a metadata tag may comprise a synonym for a keyword in the first request. For instance, if the first request includes the keyword “vaccine,” a matching metadata tag associated with the first dataset may comprise “vaccine,” “inoculation,” “injection,” “shot,” or the like.

In step 308, the processing system may determine a resource need of a second user who controls access to the first dataset, where the resource need is specified in a second request from the second user. For instance, the second user may be a data owner who owns or otherwise controls access to the first dataset. In one example, the second user may have a need for a specific type of resource (e.g., a computing resource, a personnel resource, an expertise resource, or the like). The second request may be received by the processing system via a web portal that allows the second user to build and publish a profile that is stored as part of the data exchange, where the profile describes the resource need.

In step 310, the processing system may determine that the first user can provide a first resource that satisfies the resource need, where the first resource is offered by the first user via the data exchange. For instance, just as the first user is able to specify a data need via a profile, the first user may also be able to specify via the profile any resources that the first user is willing and able to provide in exchange for access to data that satisfies the data need. In another example, resources that the first user is willing and able to exchange for access to datasets may be specified in one or more databases or catalogs. As discussed above, the resources that the first user is willing and able to provide may comprise computing resources, personnel resources, expertise resources, and/or other types of resources.

In step 312, the processing system may establish an agreement upon approval from the first user and from the second user to orchestrate an exchange of the first dataset for the first resource. For instance, the processing system may, upon determining that the first user can provide the first resource, send a first message to the first user indicating that a match to the first user's data need has been found in the first dataset. The first message may also ask the first user to confirm whether the first user is willing to provide the first resource in exchange for access to the first dataset. Similarly, the processing system may send a second message to the second user indicating that a match to the second user's resource need has been found in the first resource. The second message may also ask the second user to confirm whether the second user is willing to provide access to the first dataset in exchange for the first resource. Upon receiving affirmative responses to both the first message and the second message, the processing system may establish the agreement. A copy or summary of the agreement (e.g., an identification of the first user, the second user, the first dataset, the first resource, a time period over which the first user's access to the first dataset is valid, a time period over which the second user's access to the second resource is valid, and/or other information related to the agreement) may be stored by the processing system in a repository that is accessible to the data exchange.

In one example, if one or both of the first user and the second user responds to the first message or the second message in the negative (i.e., declines the agreement), the processing system may repeat steps 306-312 by selecting a second dataset that matches the data need of the first user and determining a second resource need of a third user who controls access to the second dataset. In this way, the processing system may identify a plurality of potential datasets that match the data need of the first user, and may rank the plurality of potential datasets from the strongest match to the weakest match. The processing system may then attempt to establish an agreement to exchange a resource of the first user for access to a dataset of the plurality of potential datasets, starting with the strongest match and working through the rankings in order until both the first user and the owner of a dataset that is currently suggested can agree on an exchange. The agreement may be stored in a repository of agreements that are orchestrated via the data exchange.

In one example, the first user and the second user may specify further terms of the agreement or may specify alterations to terms that are proposed by the processing system. For instance, as discussed above in connection with the user defined catalog 106₇ and the teaming catalog 106ₙ, a data owner and data user may directly negotiate terms of an agreement, potentially guided by predefined policies. The negotiation between the data owner and data user may also involve other parties (e.g., other data owners and/or data users) who may participate in the agreement. For instance, if the first user does not have direct access to the first resource, the first user may be able to provide a second resource to a third user in exchange for the third user providing the first resource to the second user. In a further example, the processing system may be able to automatically determine that the third user can be brought into the agreement to satisfy the data and resource needs of all parties.

In step 314, the processing system may deliver, pursuant to the agreement, the first dataset to the first user via a data pipeline. As discussed above, an intelligent controller that is part of or that is coupled to the processing system may create new schemas to handle new source data retrievals and/or to integrate new data pipeline component types, and may assemble and tear down data pipelines in real-time, as necessary to deliver the first dataset.

In optional step 316 (illustrated in phantom), the processing system may monitor the progress of execution of the agreement. For instance, since the data pipeline is used to deliver the first dataset, the processing system may be able to confirm when the first dataset was delivered to the first user. The processing system may also be able to monitor timely delivery of the first dataset to the user and/or timely delivery of the first resource to the second user by sending messages to the first user and/or the second user asking the first user and/or second user to confirm receipt of the first dataset and/or first resource. Any responses to the message(s) may be tracked against the agreement (e.g., to determine whether the first dataset and/or first resource was delivered by an agreed upon date or for an agreed upon period of time).

In optional step 318 (illustrated in phantom), the processing system may log the progress of the execution of the agreement against the agreement. For instance, the processing system may store the agreement in a repository, as described above. The processing system may update the stored agreement in order to log the progress of the execution of the agreement. Logging the process in this way may help the processing system to learn which users are most trustworthy or least trustworthy when it comes to fulfilling the terms of agreements orchestrated via the data exchange. Knowing the trustworthiness of the users may help the processing system to orchestrate better agreements (e.g., in which all parties to the agreements are satisfied with the outcome) in the future. In one example, the progress of the execution of the agreement may be logged in a chain data structure that allows user responsibilities to be traced per agreement lifecycle.

The method 300 may end in step 320.

Thus, the system 100 and the method 300 may provide an incentive-based data exchange in which data owners and data users may discover and negotiate for exchange of datasets and resources that will increase productivity and expedite project completion. The method 300 presents an example of such an exchange in its most basic form. In practice, multiple users of the system 100 (i.e., multiple data owners and/or data users) may end up interacting in order to facilitate an exchange of datasets and resources. For instance, a first user may seek access to a first dataset, without knowing that the first dataset is indirectly related to a second dataset. The system 100, however, may facilitate an interaction between the first user and a second user that allows the first user to discover and negotiate access to the second dataset as well. Thus, the system 100 encourages greater interaction between users (e.g., employees of an enterprise) who may not have otherwise had opportunity or reason to interact. This greater interaction can lead to more collaboration and improved productivity across an enterprise.

It should be noted that the method 300 may be expanded to include additional steps or may be modified to include additional operations with respect to the steps outlined above. In addition, although not specifically specified, one or more steps, functions, or operations of the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for delivering access to datasets using an incentive-based exchange, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300 or the entire method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one example, instructions and data for the present module or process 405 for delivering access to datasets using an incentive-based exchange (e.g., a software program comprising computer-executable instructions) can be loaded into memory 404 and executed by hardware processor element 402 to implement the steps, functions, or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for delivering access to datasets using an incentive-based exchange (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor, a first request from a first user endpoint device of a first user of a data exchange, wherein the first request specifies a data need of the first user;
identifying, by the processing system, a first dataset from among a plurality of datasets that is accessible via the data exchange, wherein the first dataset is determined to match the data need of the first user;
determining, by the processing system, a resource need of a second user who controls access to the first dataset, wherein the resource need is specified in a second request from a second user endpoint device of the second user;
determining, by the processing system, that the first user can provide a first resource that satisfies the resource need, wherein the first resource is offered by the first user via the data exchange;
establishing, by the processing system, an agreement upon approval from the first user and from the second user to orchestrate an exchange of the first dataset for the first resource; and
delivering, by the processing system pursuant to the agreement, the first dataset to the first user endpoint device via a data pipeline.

2. The method of claim 1, further comprising:
monitoring, by the processing system, a progress of execution of the agreement; and
logging, by the processing system, the progress of the execution of the agreement against the agreement.

3. The method of claim 2, wherein the progress of the execution is logged in a chain data structure.

4. The method of claim 2, wherein the agreement is stored in a repository that is accessible to the data exchange.

5. The method of claim 2, wherein the monitoring comprises sending messages to the first user and to the second user to confirm receipt of the first dataset and the first resource during a time period specified by the agreement.

6. The method of claim 1, wherein the first user and the second user are both employees of an enterprise on whose behalf the data exchange is implemented.

7. The method of claim 1, wherein the first resource is at least one selected from a group of: a computing resource, a personnel resource, and an expertise resource.

8. The method of claim 1, wherein an access to the first resource is for a defined period of time.

9. The method of claim 1, wherein the identifying the first dataset comprises matching metadata associated with the first dataset to a keyword in the first request.

10. The method of claim 1, wherein the determining that the first user can provide a first resource comprises matching metadata associated with the first resource to a keyword in the second request.

11. The method of claim 1, wherein the first request is stored in a first profile associated with the first user, and the second request is stored in a second profile associated with the second user.

12. The method of claim 1, wherein the establishing comprises soliciting affirmative responses from the first user and the second user to messages seeking approval of the agreement.

13. The method of claim 1, wherein the first resource is described in a database storing information about resources that are available in exchange for datasets.

14. The method of claim 1, wherein the determining that the first user can provide the first resource comprises determining that the first user can obtain the first resource in exchange for providing a second resource to a third user.

15. The method of claim 1, wherein the data pipeline is constructed dynamically by the processing system.

16. A non-transitory computer-readable medium storing instructions which, when executed by a processing system including at least one processor, cause the processing system to perform operations, the operations comprising:
receiving a first request from a first user endpoint device of a first user of a data exchange, wherein the first request specifies a data need of the first user;
identifying a first dataset from among a plurality of datasets that is accessible via the data exchange, wherein the first dataset is determined to match the data need of the first user;
determining a resource need of a second user who controls access to the first dataset, wherein the resource need is specified in a second request from a second user endpoint device of the second user;
determining that the first user can provide a first resource that satisfies the resource need, wherein the first resource is offered by the first user via the data exchange;
establishing an agreement upon approval from the first user and from the second user to orchestrate an exchange of the first dataset for the first resource; and
delivering, pursuant to the agreement, the first dataset to the first user endpoint device via a data pipeline.

17. The non-transitory computer-readable medium of claim 16, wherein the operations further comprise:
monitoring a progress of execution of the agreement; and
logging the progress of the execution of the agreement against the agreement.

18. The non-transitory computer-readable medium of claim 16, wherein the first resource is at least one selected from a group of: a computing resource, a personnel resource, and an expertise resource.

19. The non-transitory computer-readable medium of claim 16, wherein the data pipeline is constructed dynamically by the processing system.

20. A device comprising:
a processing system including at least one processor; and
a non-transitory computer-readable medium storing instructions which, when executed by the processing system, cause the processing system to perform operations, the operations comprising:
receiving a first request from a first user endpoint device of a first user of a data exchange, wherein the first request specifies a data need of the first user;
identifying a first dataset from among a plurality of datasets that is accessible via the data exchange, wherein the first dataset is determined to match the data need of the first user;
determining a resource need of a second user who controls access to the first dataset, wherein the resource need is specified in a second request from a second user endpoint device of the second user;
determining that the first user can provide a first resource that satisfies the resource need, wherein the first resource is offered by the first user via the data exchange;
establishing an agreement upon approval from the first user and from the second user to orchestrate an exchange of the first dataset for the first resource; and
delivering, pursuant to the agreement, the first dataset to the first user endpoint device via a data pipeline.
